(19) United States
(12) Patent Application Publication
(10) Pub. No.: US 2022/0056742 A1
(43) Pub. Date: Feb. 24, 2022

(54) SAFETY MAGNETIC HINGE

(71) Applicant: I Re KIM, Namyangju-si (KR)

(72) Inventor: I Re KIM, Namyangju-si (KR)

(21) Appl. No.: 17/298,570

(22) PCT Filed: Jul. 31, 2019
(86) PCT No.: PCT/KR2019/009547

§ 371 Date: May 29, 2021

(30) Foreign Application Priority Data
Nov. 30, 2018 (KR) 10-2018-0152928

(51) Int. Cl. E05C 17/56; E05D 11/06; E05D 5/06

(52) U.S. Cl. CPC E05C 17/56; E05D 11/06; E05Y 2900/132; E05Y 2600/636; E05D 5/06

(57) ABSTRACT

Disclosed is a safety magnetic hinge for preventing a door from being suddenly closed by wind, by, when the hinge opens, fixing the hinge so as not to close at a predetermined angle through a magnet installed in the hinge.

### TECHNICAL FIELD

The present invention relates to a safety magnetic hinge, and more particularly, to a safety magnetic hinge for preventing a door from being suddenly closed by wind by fixing the hinge so as not to be closed at a predetermined angle through a magnet installed on the hinge when the hinge is opened.

### BACKGROUND ART

In general, a hinge is a device configured to connect two plates, which are attached to a door and a door frame, respectively, to each other with a pin, to allow the two plates to rotate about the pin. The hinge is widely used in a room door of a common home, and broadly, in all appliances involving opening/closing of a door, including a small cabinet.

However, since an existing hinge is generally opened at an angle of 180° or more, the door may collide with a wall to cause damage to the door and the wall. In addition, the door may be closed by an unintended external force such as wind while the door is in an open state so that there has been an inconvenience to open the door again, the door and the door frame may be suddenly closed with a loud noise so as to frighten people or dogs, and sometimes, a human body may be caught in a door crevice so as to be injured.

Therefore, in order to solve the above problems, a user has propped the door against a separate support. In addition, in order to fundamentally solve the above problems, a hinge having a stopper capable of controlling a maximum opening angle of a door and a fixing device for preventing sudden closing of a door have been introduced. However, there has been no device having both functions of controlling a maximum opening angle and preventing sudden closing, and the device may have a complicated structure or a high manufacturing cost.

Meanwhile, as an improved hinge, Korean Utility Model Registration No. 20-421528 discloses a hinge having a magnet, the hinge including: a first hinge member 10 formed in a side surface thereof with a rotation hole 11, provided with a stopper 40 extending integrally from one end of the first hinge member 10 in an annular curved shape and having a magnet rod 41 attached to the stopper 40, and having a plurality of coupling holes 12 perforated through a front surface of the first hinge member 10; a second hinge member 20 formed in a side surface thereof with a rotation hole 21, and having a plurality of coupling holes 22 perforated through a front surface of the second hinge member 20; and a rotation shaft 30 formed on one side thereof with a fixing groove 31, having washers 32 provided on both sides of the rotation shaft 30 to correspond to the rotation holes 11 and 21 formed in the first hinge member 10 and the second hinge member 20, respectively, configured to pass through a plurality of bearings 33 located between the rotation holes 11 and 21, and fastened to a fixing member 35 having a fixing protrusion 34 to allow the first hinge member 10 and the second hinge member 20 to rotate, wherein the second hinge member 20 is attached to the magnet rod 41 while being opened at a predetermined angle with respect to the first hinge member 10 so as to prevent a door from being closed by wind.

However, according to the hinge having the magnet of the related art, in order to prevent the door from being closed, a process of attaching and detaching the magnet rod to and from the second hinge member is repeated every time the door is opened to cause the second hinge member to be repeatedly pulled by a pulling force of the magnet rod, so that a screw for fixing the second hinge member may protrude, and the second hinge member may be separated from the door.

### DETAILED DESCRIPTION OF THE INVENTION

### Technical Problem

The present invention has been proposed to solve the above-described problems, and an object of the present invention is to provide a safety magnetic hinge for preventing a door from being suddenly closed by wind by firmly fixing the hinge so as not to be closed at a predetermined angle through a magnet installed on the hinge when the hinge is opened.

In addition, an object of the present invention is to provide a safety magnetic hinge having a structure that is firmly coupled to a door and a door frame so that the door may be firmly installed on the door frame, and configured such that a coupling state of the hinge to the door may not be loosened even when a process of attaching and detaching a magnet rod to and from a hinge member is repeated to fix an open door.

### Technical Solution

The above objects may be achieved by a safety magnetic hinge including: a door hinge member including a coupling plate having a plurality of coupling holes and fixed to one end surface of a door, and a cylindrical shaft formed at a rear end of the coupling plate; a stopper member having one end coupled to one surface of the coupling plate to extend to a rear side of the door hinge member, and including a round plate formed on one side of the cylindrical shaft, an installation plate extending to a rear side of the round plate and formed at an end thereof with a bent part bent to an opposite side of the round plate, and a magnet rod attached to a front surface of the installation plate; a door frame hinge member including a fixing plate having a plurality of coupling holes and fixed to an inner surface of a door frame, and a cylindrical shaft formed at a rear end of the fixing plate; an attachment fixing member including a bent plate bent and extending from an end of the cylindrical shaft of the door frame hinge member to a rear side of the cylindrical shaft, and an attachment plate bent from a rear side of the bent plate to an opposite side of the bent plate, installed on a rear side of the door frame, and to which the magnet rod installed on the installation plate is selectively attached and fixed; a hinge pin inserted into the cylindrical shafts to rotatably connect the door frame hinge member to the door hinge member; and a washer inserted between the cylindrical shafts, wherein, when the door is opened from the door frame in a state in which the door hinge member and the door frame hinge member are coupled to the door and the door frame, respectively, as the door hinge member is opened at a predetermined angle with respect to the door frame hinge member, the magnet rod of the stopper member is attached and fixed to the attachment plate that is closely supported against the door frame so as to prevent the door from being closed by wind.

In this case, preferably, the cylindrical shaft of the door frame hinge member is formed by rolling a protruding piece protruding from the rear end of the fixing plate to a rear side of the fixing plate in a cylindrical shape, and the attachment fixing member is formed such that the bent plate is formed by bending a part of the protruding piece, which is rolled in the cylindrical shape to form the cylindrical shaft of the door frame hinge member, to allow the part of the protruding piece to be inclined to a rear side of the cylindrical shaft, and the attachment plate is formed by bending an end of the protruding piece formed with the bent plate to allow the end of the protruding piece to be perpendicular to an opposite side of the fixing plate.

In addition, preferably, the magnet rod is installed on the bent part of the installation plate so as to be attached with the attachment plate at a position in which the door is rotated from the door frame by 90 degrees or more, a fastening hole is formed in a front surface of the bent part of the installation plate, a through-hole corresponding to the fastening hole is formed in the magnet rod, and the safety magnetic hinge further comprises a rotation angle adjustment plate provided on a front surface of the magnet rod, having an adjustment hole corresponding to the through-hole and extending in a lateral direction, having a position that is adjustable in the lateral direction to protrude to an opposite side of the magnet rod, and to which the attachment plate is attached when the door is rotated, a bolt is inserted into the adjustment hole of the rotation angle adjustment plate and the through-hole of the magnet rod on a rear surface of the rotation angle adjustment plate so as to be fastened to the fastening hole of the bent part, so that the magnet rod and the rotation angle adjustment plate are coupled to the bent part of the installation plate, and the rotation angle adjustment plate fixed to the installation plate through the bolt is fixed to protrude from the magnet rod to an opposite side of the magnet rod with a variable degree of protrusion so as to allow an opposite end of the rotation angle adjustment plate to be attached and fixed to the attachment plate at various angles, so that the door is maintained in an open state at the various angles.

### Advantageous Effects

According to the present invention, the safety magnetic hinge may prevent the door from being suddenly closed by wind by firmly fixing the hinge so as not to be closed at a predetermined angle through the magnet installed on the hinge when the hinge is opened, so that the door can be prevented from being broken and damaged, and a body of a user can be prevented from being caught in a door crevice.

### DESCRIPTION OF THE DRAWINGS

FIG. 1 is an exploded perspective view showing a safety magnetic hinge according to the present invention.

FIG. 2 is a perspective view showing a combined state of the safety magnetic hinge according to the present invention.

FIGS. 3a and 3b are sectional views showing states in which the safety magnetic hinge according to the present invention is installed, respectively.

FIG. 4 is a view for describing fabrication of a door frame hinge member and an attachment fixing member of the safety magnetic hinge according to the present invention.

FIGS. 5a and 5b are views for describing an operation of the safety magnetic hinge according to the present invention.

FIG. 6 is a sectional view showing a safety magnetic hinge according to another exemplary embodiment of the present invention.

FIGS. 7 to 9 are views for describing an operation of the safety magnetic hinge according to FIG. 6.

FIG. 10 is a view showing an example in which a structure of the safety magnetic hinge according to the present invention is applied to an easy hinge.

### BEST MODE

Hereinafter, a safety magnetic hinge according to the present invention will be described in detail with reference to the accompanying drawings.

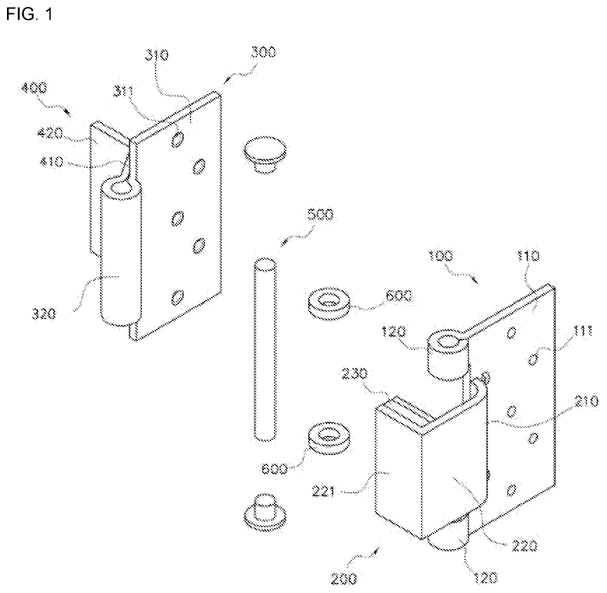

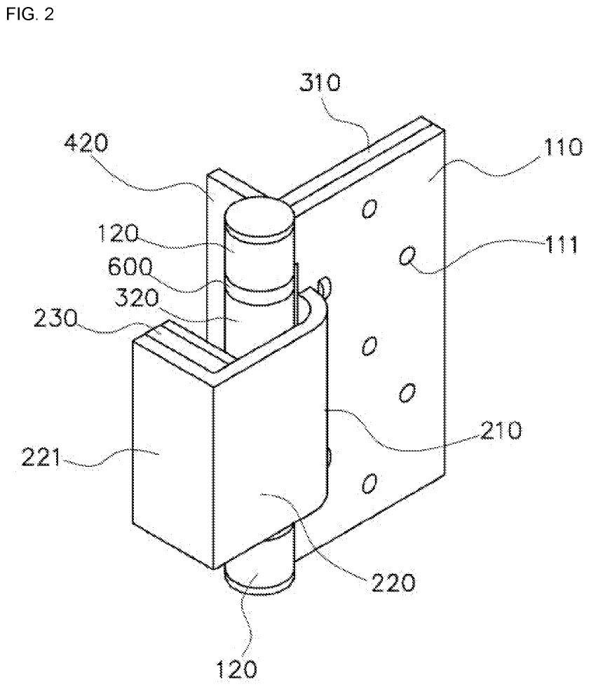

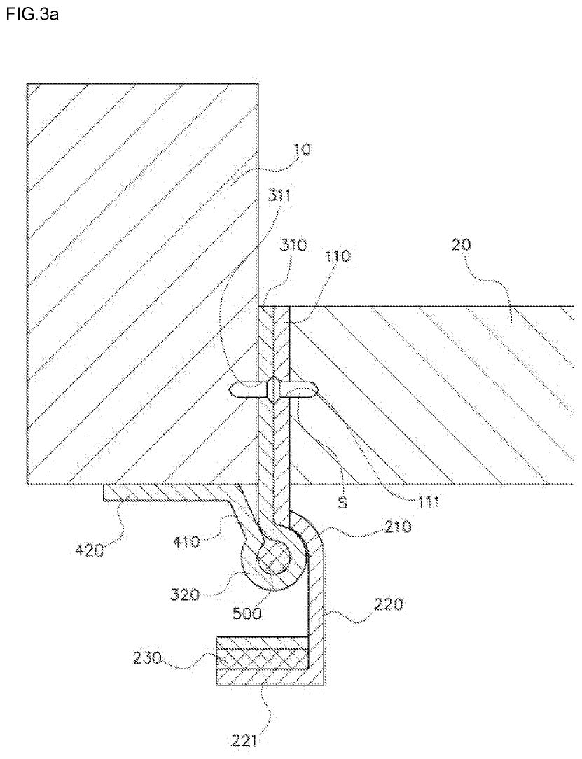

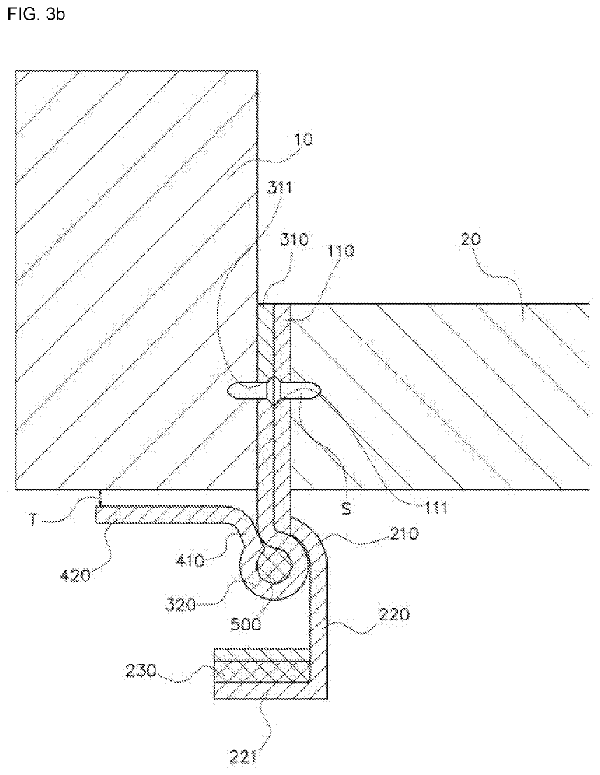

Among the accompanying drawings, FIG. 1 is an exploded perspective view showing a safety magnetic hinge according to the present invention, FIG. 2 is a perspective view showing a combined state of the safety magnetic hinge according to the present invention, and FIGS. 3a and 3b are sectional views showing states in which the safety magnetic hinge according to the present invention is installed, respectively.

Referring to the above drawings, according to the present invention, the safety magnetic hinge may prevent a door from being suddenly closed by wind by fixing the hinge so as not to be closed at a predetermined angle through a magnet rod installed on the hinge, and the safety magnetic hinge may include a door hinge member 100, a stopper member 200, a door frame hinge member 300, an attachment fixing member 400, a hinge pin 500, and a washer 600.

The door hinge member 100 may include a coupling plate 110 having a plurality of coupling holes 111 and fixed to one end surface of a door 20, and a cylindrical shaft 120 formed at a rear end of the coupling plate 110. In this case, the door hinge member 100 is preferably formed of stainless steel that is light and has excellent mechanical strength.

In this case, the coupling plate 110 refers to a member that is attached and fixed to the door 20 so as to be connected to a door frame 10, and the coupling plate 110 may be coupled to the door 20 with a screw S that is fastened through the coupling hole 111. In addition, the cylindrical shaft 120 refers to a part through which the hinge pin 500, which will be described below, passes to allow the door hinge member 100 to rotate, and at least one cylindrical shaft 120 may be provided to satisfy a minimum configuration required for the rotation. In the present disclosure, an embodiment in which two cylindrical shafts 120 are formed will be described. With regard to the cylindrical shaft 120, the coupling plate 110 may be cut by a predetermined length to have a predetermined width from one end of the coupling plate 110 so as to be formed in a concavo-convex shape, and a protruding portion of the coupling plate 110 may be bent in a circular shape so as to be configured in a form of a tube, so that a hollow cylindrical shaft 120 may be formed. Preferably, the cylindrical shafts 120 may have the same diameter and may be formed in a perfect circle, so that the cylindrical shaft 120 may smoothly rotate on the hinge pin.

The stopper member 200 refers to a part to which an attachment plate of the attachment fixing member 400, which will be described below, is attached to fix the door so that the door may not rotate, and the stopper member 200 may have one end coupled to one surface of the coupling plate 110 to extend to a rear side of the door hinge member 100.

In more detail, the stopper member 200 may have one end coupled to one surface of the coupling plate 110 to extend to the rear side of the door hinge member 100, and may include a round plate 210 formed on one side of the cylindrical shaft 120, an installation plate 220 extending to a rear side of the round plate 210 and formed at an end thereof with a bent part 221 bent to an opposite side of the round plate 210, and a magnet rod 230 attached to a front surface of the installation plate 220.

In this case, the round plate 210 may have a rounded shape as if the round plate 210 surrounds an outer side of the cylindrical shaft 120, and may extend from one side surface of the coupling plate 110 of the door hinge member 100. In addition, the installation plate 220 may extend to the rear side of the round plate 210, and the magnet rod 230 may be attached and coupled to a front surface of the bent part 221. In this case, the installation plate 220 is preferably formed in a predetermined length in a vertical direction so that the magnet rod 230 installed on the bent part 221 of the installation plate 220 may be attached to a rear surface of the attachment plate, which will be described below, over a wide range. In addition, the magnet rod 230 installed on the installation plate 220 may be attached to the attachment plate installed on a rear surface of the door frame when the door hinge member 100 and the door frame hinge member 300, which will be described below, are opened at a predetermined angle, so as to serve to prevent the door from being closed by an unintended external force such as wind. The magnet rod 230 is preferably configured by selecting a magnet having strong magnetic properties to prevent the door from being closed even by strong wind.

The door frame hinge member 300 may include a fixing plate 310 having a plurality of coupling holes 311 and fixed to an inner surface of the door frame 10, and a cylindrical shaft 320 formed at a rear end of the fixing plate 310. In this case, the door frame hinge member 300 is preferably formed of stainless steel that is light and has excellent mechanical strength.

In this case, the fixing plate 310 refers to a member that is attached and fixed to the door frame 10 so as to be connected to the door 20, and the fixing plate 310 may be coupled to the door frame 10 with a screw S that is fastened through the coupling hole 311. In addition, the cylindrical shaft 320 refers to a part through which the hinge pin 500, which will be described below, passes to allow the door frame hinge member 300 to rotate, and at least one cylindrical shaft 320 may be provided to satisfy a minimum configuration required for the rotation. In the present disclosure, an embodiment in which one cylindrical shaft 320 is formed will be described. With regard to the cylindrical shaft 320, the fixing plate 310 may be cut by a predetermined length to have a predetermined width from a rear end of the fixing plate 310 so as to be formed in a concavo-convex shape, and a protruding portion of the fixing plate 310 may be bent in a circular shape so as to be configured in a form of a tube, so that a hollow cylindrical shaft 320 may be formed. The cylindrical shaft 320 is preferably formed in a perfect circle so as to rotate smoothly.

The attachment fixing member 400 may be provided on a rear side of the door frame 10 so as to be attached and fixed to the magnet rod 230, and may serve to reinforce and support the door frame hinge member 300 while being supported against the rear surface of the door frame 10 such that the door frame hinge member 300 may be firmly installed.

In more detail, the attachment fixing member 400 may include a bent plate 410 bent and extending from an end of the cylindrical shaft 320 of the door frame hinge member 300 to a rear side of the cylindrical shaft 320, and an attachment plate 420 bent from a rear side of the bent plate 410 to an opposite side of the bent plate 410, installed on a rear side of the door frame 10, and to which the magnet rod 230 installed on the installation plate 220 is selectively attached and fixed. In this case, the attachment plate 420 may be installed in close contact with the rear surface of the door frame 10 as shown in FIG. 3a, or may be spaced apart from the rear surface of the door frame 10 by a predetermined distance T as shown in FIG. 3b.

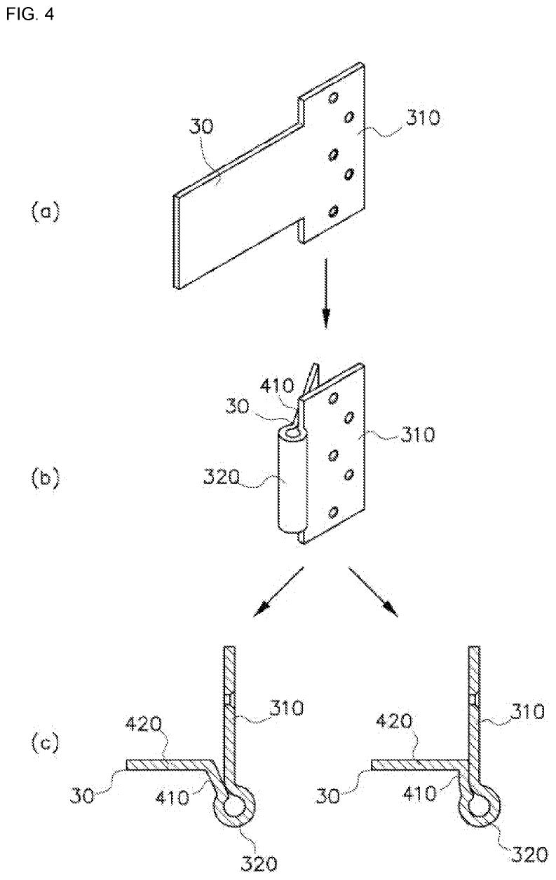

Meanwhile, the attachment fixing member 400 is preferably fabricated together with the cylindrical shaft 320 of the door frame hinge member at the same time when the cylindrical shaft 320 of the door frame hinge member is formed. In other words, as shown in FIG. 4, in a state of (a), the cylindrical shaft 320 of the door frame hinge member may be formed by rolling a protruding piece 30 protruding from the rear end of the fixing plate 310 to a rear side of the fixing plate 310 in a cylindrical shape as shown in (b), and the attachment fixing member 400 may be formed such that the bent plate 410 is formed by bending a part of the protruding piece 30, which is rolled in the cylindrical shape to form the cylindrical shaft 320 of the door frame hinge member, to allow the part of the protruding piece 30 to be inclined to a rear side of the cylindrical shaft 320, and the attachment plate 420 is formed by bending an end of the protruding piece 30 formed with the bent plate 410 to allow the end of the protruding piece 30 to be perpendicular to an opposite side of the fixing plate 310 as shown in (c). In this case, as shown in the drawings, the bent plate 410 may be bent so as to be inclined to the opposite side of the fixing plate 310, or may be bent in the vertical direction to extend in parallel with the fixing plate 310. Through such a process, the attachment fixing member 400 may be integrally formed with the door frame fixing member 300, and the door frame fixing member 300 and the attachment fixing member 400 may be simultaneously fabricated, so that the fabrication may be facilitated, and a manufacturing cost may be reduced.

The hinge pin 500 may be inserted into the cylindrical shafts 120 and 320 to rotatably connect the door hinge member 100 to the door frame hinge member 300, and the hinge pin 500 may be configured as a circular pin-shaped shaft so as to be fitted into the cylindrical shafts 120 and 320 to allow the door hinge member 100 and the door frame hinge member 300 to rotate while the door hinge member 100 and the door frame hinge member 300 are coupled to each other.

The washer 600 may be inserted between the cylindrical shafts 120 and 320 so that the cylindrical shaft 120 of the door hinge member and the cylindrical shaft 320 of the door frame hinge member may smoothly rotate on the hinge pin 400.

An operation and an effect of the safety magnetic hinge according to the present invention, which is configured as described above, will be described.

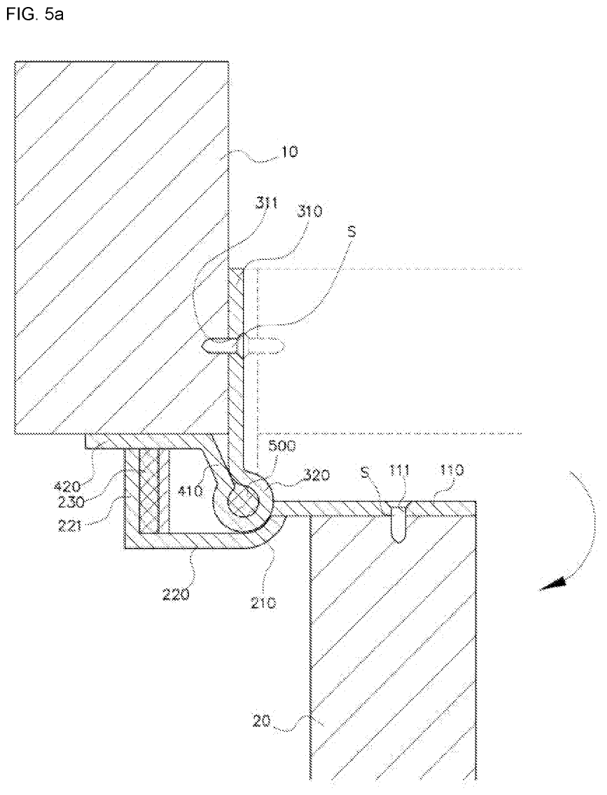

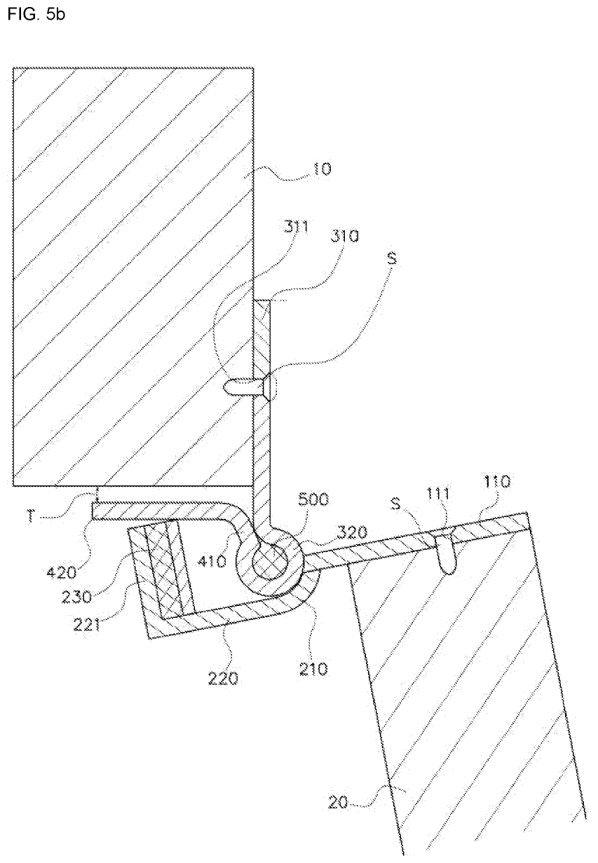

As shown in FIG. 5a, according to the safety magnetic hinge of the present invention, when the door hinge member 100 and the door frame hinge member 300 are coupled to the door 20 and the door frame 10, respectively, the attachment fixing member 400 may be closely supported against the rear surface of the door frame 10.

As described above, when the door 20 is opened from the door frame 10 in a state in which the safety magnetic hinge according to the present invention is installed on the door frame 10 and the door 20, as the door hinge member 100 is opened at a predetermined angle with respect to the door frame hinge member 300, the magnet rod 230 installed on the stopper member 200 may be attached and fixed to the attachment plate 420 of the attachment fixing member 400. Therefore, the door hinge member 100 may be fixed to the attachment fixing member 400 so as to prevent the door 20 from being closed by wind. In this case, since the magnet rod 230 installed on the stopper member is attached to the attachment plate 420 of the attachment fixing member without interfering with the screws configured to couple the hinge to the door frame 10 and the door 20, even when a process of attaching and detaching the magnet rod 230 to and from the attachment plate 420 is repeated, a coupling state of the hinge to the door may not be loosened.

In addition, as shown in FIG. 5b, when the attachment plate 420 is spaced apart from the rear surface of the door frame 10 by the predetermined distance T, the magnet rod 230 installed on the stopper member may be attached to the attachment plate 420 while the rotation is performed by 90 degrees or less. Therefore, the door may be maintained in a fixed state while being opened at 90 degrees or less. As described above, according to the present invention, since the attachment plate 420 may be installed by adjusting the predetermined distance T by which the attachment plate 420 is spaced apart from the rear surface of the door frame 10, the magnet rod 230 may be attached and fixed to the attachment plate 420 at various angles (e.g., 80 degrees, 75 degrees, 70 degrees, etc.), so that the door 20 may be maintained in an open state from the door frame 10 at the various angles.

Meanwhile, according to the present invention, when the hinge is opened as the door 20 is opened, the door hinge member 100 may be fixed at various angles through the magnet rod 230, so that the door 20 may be maintained in the open state at the various angles.

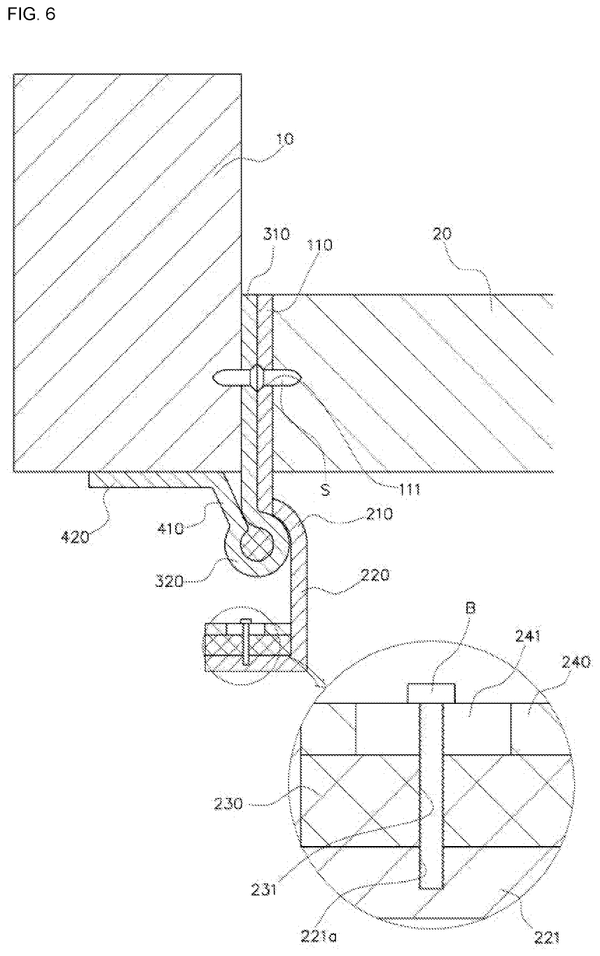

To this end, as shown in FIG. 6, the magnet rod 230 may be installed on the bent part 221 of the installation plate 220 so as to be attached with the attachment plate 420 at a position in which the door 20 is rotated from the door frame 10 by 90 degrees or more.

In addition, a fastening hole 221a may be formed in a front surface of the bent part 221 of the installation plate, a through-hole 231 corresponding to the fastening hole 221a may be formed in the magnet rod 230, and the safety magnetic hinge may further include a rotation angle adjustment plate 240 provided on a front surface of the magnet rod 230, having an adjustment hole 241 corresponding to the through-hole 231 and extending in a lateral direction, having a position that is adjustable in the lateral direction to protrude to an opposite side of the magnet rod 230, and to which the attachment plate 420 is attached when the door 20 is rotated. With the above configuration, a bolt B may be inserted into the adjustment hole 241 of the rotation angle adjustment plate 240 and the through-hole 231 of the magnet rod 230 on a rear surface of the rotation angle adjustment plate 240 so as to be fastened to the fastening hole 221a of the bent part 221, so that the magnet rod 230 and the rotation angle adjustment plate 240 may be coupled to the bent part 221 of the installation plate in an assembling manner.

With the above configuration, the rotation angle adjustment plate 240 fixed to the installation plate 220 through the bolt B may be fixed to protrude from the magnet rod 230 to an opposite side of the magnet rod 230 with a variable degree of protrusion so as to allow an opposite end of the rotation angle adjustment plate 240 to be attached and fixed to the attachment plate 420 at various angles, so that the door 20 may be maintained in an open state at the various angles.

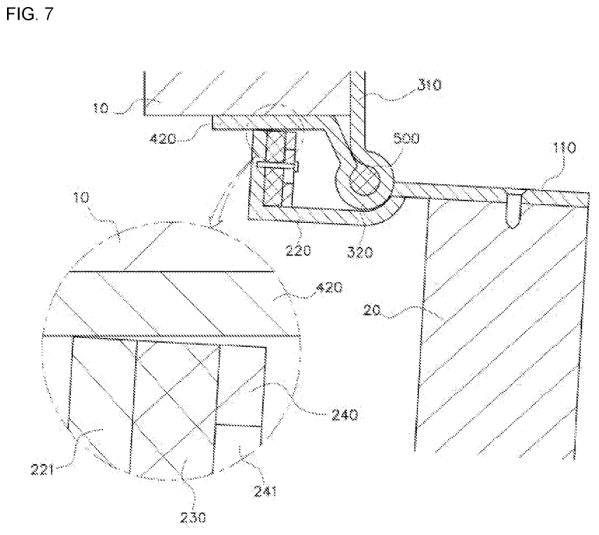

In other words, as shown in FIG. 7, when the rotation angle adjustment plate 240 and the magnet rod 230 are fixed at the same position, the opposite end of the rotation angle adjustment plate may be attached to the attachment plate while the rotation is performed by 90 degrees or more. Therefore, the door may be maintained in a fixed state while being opened at 90 degrees or more.

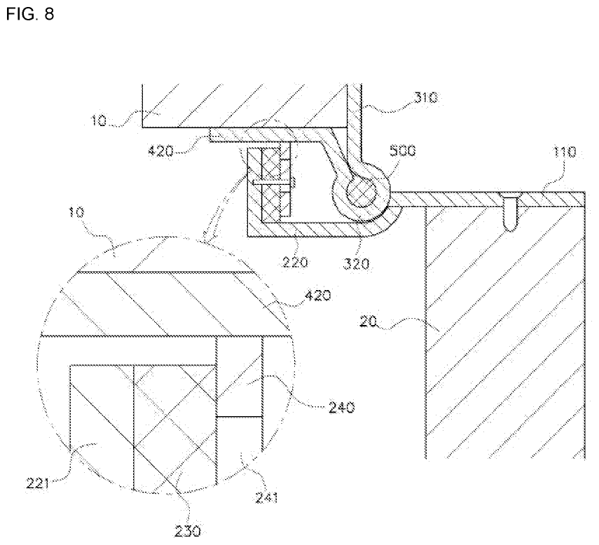

In addition, as shown in FIG. 8, when the rotation angle adjustment plate 240 is fixed while slightly protruding from the magnet rod 230, the opposite end of the rotation angle adjustment plate may be attached to the attachment plate while the rotation is performed by 90 degrees. Therefore, the door may be maintained in a fixed state while being opened at 90 degrees.

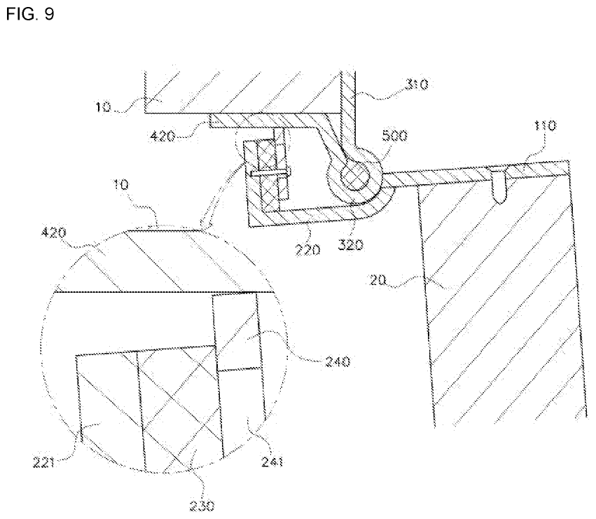

In addition, as shown in FIG. 9, when the rotation angle adjustment plate 240 is fixed while further protruding from the magnet rod 230, the opposite end of the rotation angle adjustment plate may be attached to the attachment plate while the rotation is performed by 90 degrees or less. Therefore, the door may be maintained in a fixed state while being opened at 90 degrees or less.

As described above, according to the present embodiment, the rotation angle adjustment plate 240 may be fixed to the installation plate 220 through the bolt B to protrude from the magnet rod 230 to the opposite side of the magnet rod 230 with a variable degree of protrusion so as to allow the opposite end of the rotation angle adjustment plate 240 to be attached and fixed to the attachment plate 420 at various angles (e.g., 80 degrees, 90 degrees, 100 degrees, etc.), so that the door 20 may be maintained in an open state from the door frame 10 at the various angles.

Although specific embodiments of the present invention have been shown and described above, it will be readily understood by those of ordinary skill in the art that various changes and modifications can be made without departing from the idea and scope of the invention as defined by the claims.

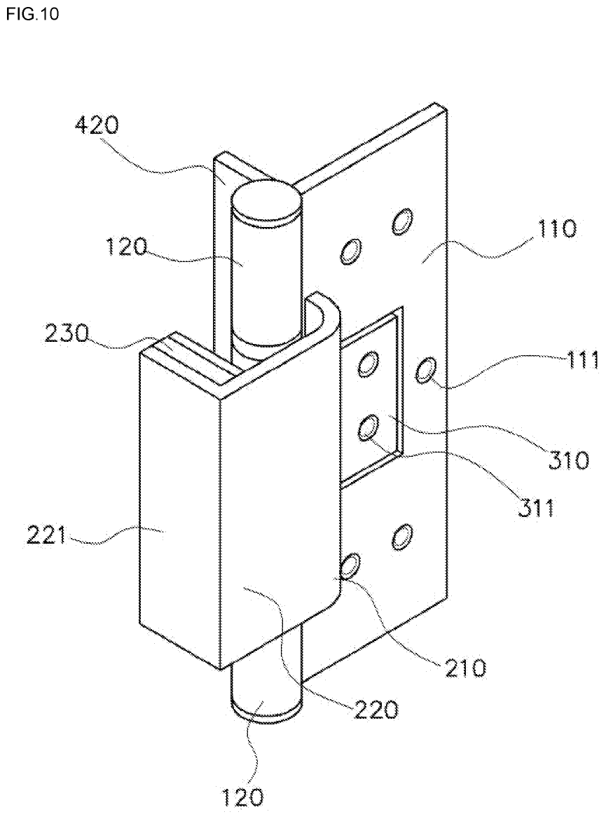

Exemplarily, as shown in FIG. 10, the safety magnetic hinge according to the present invention may be applied to a hinge (also known as “easy hinge”) having a structure in which the door frame hinge member is accommodated inside the door hinge member.

### DESCRIPTION OF REFERENCE NUMERALS

| | |
|---|---|
| 100: Door hinge member | 200: Stopper member |

| 300: Door frame hinge member | | 400: Attachment fixing member |
|---|---|---|
| 500: Hinge pin | 600: Washer | |

### INDUSTRIAL APPLICABILITY

There is industrial applicability that when the safety magnetic hinge according to the present invention is applied, the safety magnetic hinge may prevent the door from being suddenly closed by wind by firmly fixing the hinge so as not to be closed at a predetermined angle through the magnet installed on the hinge when the hinge is opened, so that the door can be prevented from being broken and damaged, and a body of a user can be prevented from being caught in a door crevice.

1. A safety magnetic hinge comprising:
a door hinge member including a coupling plate having a plurality of coupling holes and fixed to one end surface of a door, and a cylindrical shaft formed at a rear end of the coupling plate;
a stopper member having one end coupled to one surface of the coupling plate to extend to a rear side of the door hinge member, and including a round plate formed on one side of the cylindrical shaft, an installation plate extending to a rear side of the round plate and formed at an end thereof with a bent part bent to an opposite side of the round plate, and a magnet rod attached to a front surface of the installation plate;
a door frame hinge member including a fixing plate having a plurality of coupling holes and fixed to an inner surface of a door frame, and a cylindrical shaft formed at a rear end of the fixing plate;
an attachment fixing member including a bent plate bent and extending from an end of the cylindrical shaft of the door frame hinge member to a rear side of the cylindrical shaft, and an attachment plate bent from a rear side of the bent plate to an opposite side of the bent plate, installed on a rear side of the door frame, and to which the magnet rod installed on the installation plate is selectively attached and fixed;
a hinge pin inserted into the cylindrical shafts to rotatably connect the door frame hinge member to the door hinge member; and
a washer inserted between the cylindrical shafts,
wherein, when the door is opened from the door frame in a state in which the door hinge member and the door frame hinge member are coupled to the door and the door frame, respectively, as the door hinge member is opened at a predetermined angle with respect to the door frame hinge member, the magnet rod of the stopper member is attached and fixed to the attachment plate that is closely supported against the door frame so as to prevent the door from being closed by wind.

2. The safety magnetic hinge of claim 1, wherein the cylindrical shaft of the door frame hinge member is formed by rolling a protruding piece protruding from the rear end of the fixing plate to a rear side of the fixing plate in a cylindrical shape, and the attachment fixing member is formed such that the bent plate is formed by bending a part of the protruding piece, which is rolled in the cylindrical shape to form the cylindrical shaft of the door frame hinge member, to allow the part of the protruding piece to be inclined to a rear side of the cylindrical shaft, and the attachment plate is formed by bending an end of the protruding piece formed with the bent plate to allow the end of the protruding piece to be perpendicular to an opposite side of the fixing plate.

3. The safety magnetic hinge of claim 1, wherein the magnet rod is installed on the bent part of the installation plate so as to be attached with the attachment plate at a position in which the door is rotated from the door frame by 90 degrees or more,
a fastening hole is formed in a front surface of the bent part of the installation plate, a through-hole corresponding to the fastening hole is formed in the magnet rod, and the safety magnetic hinge further comprises a rotation angle adjustment plate provided on a front surface of the magnet rod, having an adjustment hole corresponding to the through-hole and extending in a lateral direction, having a position that is adjustable in the lateral direction to protrude to an opposite side of the magnet rod, and to which the attachment plate is attached when the door is rotated,
a bolt is inserted into the adjustment hole of the rotation angle adjustment plate and the through-hole of the magnet rod on a rear surface of the rotation angle adjustment plate so as to be fastened to the fastening hole of the bent part, so that the magnet rod and the rotation angle adjustment plate are coupled to the bent part of the installation plate, and
the rotation angle adjustment plate fixed to the installation plate through the bolt is fixed to protrude from the magnet rod to an opposite side of the magnet rod with a variable degree of protrusion so as to allow an opposite end of the rotation angle adjustment plate to be attached and fixed to the attachment plate at various angles, so that the door is maintained in an open state at the various angles.
